(19) United States
(12) Patent Application Publication
(10) Pub. No.: US 2026/0002819 A1
(43) Pub. Date: Jan. 1, 2026

(54) IN-VEHICLE DEVICE AND OUTPUT METHOD

(71) Applicant: Panasonic Automotive Systems Co., Ltd., Kanagawa (JP)

(72) Inventors: Motonobu UCHIMURA, Kanagawa (JP); Yoshiteru HAYASHI, Hyogo (JP); Koyo MINAMIKAWA, Osaka (JP)

(73) Assignee: Panasonic Automotive Systems Co., Ltd., Kanagawa (JP)

(21) Appl. No.: 19/241,759

(22) Filed: Jun. 18, 2025

(30) Foreign Application Priority Data
Jun. 26, 2024 (JP) 2024-103166

(51) Int. Cl. G01K 3/00; G01K 1/02

(52) U.S. Cl. CPC G01K 3/005; G01K 1/026

(57) ABSTRACT

An in-vehicle device is a device provided in a vehicle, and includes: a CPU; a temperature obtainer and operation rate obtainer that repeatedly obtain obtainment data indicating at least an operation status of the CPU; a condition determiner that determines, for each of a plurality of items of obtainment data resulting from repeatedly obtaining the obtainment data, whether the item of obtainment data satisfies an extraction condition set in advance; and an outputter that outputs output data based only on one or more items of obtainment data determined to satisfy the extraction condition from among the plurality of items of obtainment data.

### CROSS REFERENCE TO RELATED APPLICATION

The present application is based on and claims priority of Japanese Patent Application No. 2024-103166 filed on Jun. 26, 2024.

### FIELD

The present disclosure relates to a device provided in a vehicle, etc.

### BACKGROUND

In-vehicle devices provided in vehicles have been proposed conventionally. For example, Patent Literature (PTL) 1 discloses an in-vehicle information terminal that provides a plurality of functions to the driver of the vehicle, as an example of an in-vehicle device. The in-vehicle information terminal notifies a server of information about the driver's usage of each function at a predetermined timing. In other words, the in-vehicle information terminal outputs information about the usage of each function.

### CITATION LIST

### Patent Literature

PTL 1: Japanese Unexamined Patent Application Publication No. 2009-250811

### SUMMARY

However, the in-vehicle information terminal according to PTL 1 can be improved upon.

In view of this, the present disclosure provides an in-vehicle device, etc. capable of improving upon the above related art.

An in-vehicle device according to one aspect of the present disclosure is an in-vehicle device provided in a vehicle, including: a central processing unit (CPU); an obtainer that repeatedly obtains obtainment data indicating at least an operation status of the CPU; a condition determiner that determines, for each of a plurality of items of obtainment data resulting from repeatedly obtaining the obtainment data, whether the item of obtainment data satisfies an extraction condition set in advance; and an outputter that outputs output data based only on one or more items of obtainment data determined to satisfy the extraction condition from among the plurality of items of obtainment data.

These general and specific aspects may be implemented using a system, a method, an integrated circuit, a computer program, or a computer-readable recording medium such as compact disc-read only memory (CD-ROM), or any combination of a system, a method, an integrated circuit, a computer program, and a recording medium. The recording medium may be a non-transitory recording medium.

An in-vehicle device according to one aspect of the present disclosure is capable of improving upon the above related art.

Further advantages and effects according to one aspect of the present disclosure will become apparent from the specification and drawings. Such advantages and/or effects are provided by some embodiments and features described in the specification and drawings, but not all of the features are necessarily required.

### BRIEF DESCRIPTION OF DRAWINGS

These and other advantages and features of the present disclosure will become apparent from the following description thereof taken in conjunction with the accompanying drawings that illustrate a specific embodiment of the present disclosure.

FIG. 1 is a diagram illustrating an example of a communication system in an embodiment.

FIG. 2 is a diagram illustrating an example of the structures of an in-vehicle system and in-vehicle device in the embodiment.

FIG. 3 is a diagram for explaining the process operation of a condition determiner in the embodiment.

FIG. 4 is a diagram for explaining the process operation of a degenerate data calculator in the embodiment.

FIG. 5 is a flowchart illustrating an example of the process operation of the in-vehicle device in the embodiment.

FIG. 6 is a diagram for explaining the process operation of an outputter and a condition determiner in Variation 1 of the embodiment.

FIG. 7 is a flowchart illustrating an example of the process operation of an in-vehicle device in Variation 1 of the embodiment.

FIG. 8 is a flowchart illustrating an example of the process operation of an in-vehicle device in Variation 2 of the embodiment.

FIG. 9 is a diagram illustrating some examples of degeneration targets and extraction conditions in Variation 3 of the embodiment.

### DESCRIPTION OF EMBODIMENT

### (Underlying Knowledge Forming Basis of the Present Disclosure)

The present inventors have found the following problem with the in-vehicle information terminal of PTL 1 described in the “Background” section.

Recently, software programs such as application programs installed on in-vehicle devices have been evolving year by year, which has increased the processing load on CPUs in in-vehicle devices. The trend is that it has become commonplace to update software programs to improve the functionality of in-vehicle devices or add new functions. What software programs are installed on an in-vehicle device and how the software programs are used for the in-vehicle device depend on the user. Whether it is okay to install a software program needs to be determined based on the performance margin of the in-vehicle device.

The in-vehicle information terminal of PTL 1 transmits, for example, information indicating that a specific function has been used, to the server. Statistics can be taken based on such information and used to improve the functions of the in-vehicle information terminal. However, since the operation status of the CPU in the in-vehicle information terminal cannot be known from the information, it is impossible to determine how much performance margin the CPU has.

Hence, for example, there is a possibility that, when requested by the user, the server installs a software program on the in-vehicle information terminal without understanding the operation status of the in-vehicle information terminal. As a result, the processing load on the CPU in the in-vehicle information terminal may increase, causing deterioration of the responsiveness of the CPU. Moreover, the amount of heat generated by the CPU may increase, causing a failure of the CPU.

In addition, since the data amount of information transmitted by the in-vehicle information terminal of PTL 1 is enormous, communications used for the functions of the in-vehicle information terminal may be hindered, the responsiveness of the functions may deteriorate, and communication charges may increase.

In view of this, an in-vehicle device according to a first aspect of the present disclosure is an in-vehicle device provided in a vehicle, including: a central processing unit (CPU); an obtainer that repeatedly obtains obtainment data indicating at least an operation status of the CPU; a condition determiner that determines, for each of a plurality of items of obtainment data resulting from repeatedly obtaining the obtainment data, whether the item of obtainment data satisfies an extraction condition set in advance; and an outputter that outputs output data based only on one or more items of obtainment data determined to satisfy the extraction condition from among the plurality of items of obtainment data.

Thus, the output data based on the obtainment data indicating at least the operation status of the CPU is output, so that the operation status of the CPU can be easily understood from the output data. Therefore, for example, when a server receives the output data, the server can understand the operation status of the CPU and easily know how much margin the operation status of the CPU has, and can appropriately determine whether it is okay to install a software program on the in-vehicle device. Since the output data that is output is based only on one or more items of obtainment data determined to satisfy the extraction condition from among the plurality of items of obtainment data resulting from repeatedly obtaining the obtainment data, the amount of output data that is output can be reduced compared to when all items of obtainment data resulting from repeatedly obtaining the obtainment data are output as output data. Accordingly, the amount of output data that is output can be reduced while enabling easy understanding of the operation status of the CPU from the output data.

With the in-vehicle information terminal of PTL 1, it is difficult to easily understand from the output information how much margin the operation status of the CPU in the in-vehicle information terminal has, and also the data amount of information that is output may be enormous. The present disclosure provides an in-vehicle device that can reduce the amount of data that is output while enabling easy understanding of the operation status of the CPU from the data.

An in-vehicle device according to a second aspect may further include: a communicator that communicates with a server outside the vehicle, and the outputter may output the output data by causing the communicator to transmit the output data to the server. The second aspect may be subordinate to the first aspect.

Thus, the server can receive the output data. As a result, the server can understand the operation status of the CPU in the in-vehicle device and easily know how much margin the operation status of the CPU has, and can appropriately determine whether it is okay to install a software program on the in-vehicle device.

An in-vehicle device according to a third aspect may further include: a first storage that stores the output data; and a second storage, and the outputter may output the output data by reading the output data from the first storage and storing the output data in the second storage. The third aspect may be subordinate to the first aspect or the second aspect. For example, the first storage is a recording medium for temporarily storing the output data.

Thus, the output data can be saved in the second storage. The output data can then be read from the second storage at any time, and the operation status of the CPU can be easily understood based on the output data.

An in-vehicle device according to a fourth aspect may further include: a degenerate data calculator that, when the condition determiner determines that two or more items of obtainment data satisfy the extraction condition from among the plurality of items of obtainment data, calculates degenerate data from the two or more items of obtainment data determined to satisfy the extraction condition, the degenerate data being smaller in data amount than a total of the two or more items of obtainment data, and the outputter may output the degenerate data as the output data. The fourth aspect may be subordinate to any one of the first aspect to the third aspect.

Thus, the degenerate data that is smaller in data amount than the total of the two or more items of obtainment data determined to satisfy the extraction condition is output as output data. In this way, the amount of output data can be reduced compared to when the two or more items of obtainment data determined to satisfy the extraction condition are output as output data.

In an in-vehicle device according to a fifth aspect, for each extraction period during which obtainment data satisfying the extraction condition is repeatedly and continuously obtained by the obtainer, the degenerate data calculator may calculate the degenerate data based on the two or more items of obtainment data obtained by the obtainer during the extraction period. The fifth aspect may be subordinate to the fourth aspect.

Thus, degenerate data is calculated for each extraction period, so that the accuracy of the operation status of the CPU indicated by degenerate data can be enhanced compared to when one item of degenerate data is calculated for a plurality of extraction periods.

In an in-vehicle device according to a sixth aspect, each of the two or more items of obtainment data determined to satisfy the extraction condition may indicate a numerical value as the operation status of the CPU, and the degenerate data may indicate a largest value, a smallest value, a mode value, a median value, an average value, or a histogram of numerical values indicated by the two or more items of obtainment data. The sixth aspect may be subordinate to the fourth aspect or the fifth aspect.

Thus, the amount of degenerate data can be reduced while the degenerate data appropriately indicates the operation status of the CPU indicated by each of the two or more items of obtainment data determined to satisfy the extraction condition. The amount of output data that is output can therefore be reduced effectively.

In an in-vehicle device according to a seventh aspect, the outputter may output the output data when an ignition switch of the vehicle is turned off or when processing of the in-vehicle device ends. The seventh aspect may be subordinate to any one of the first aspect to the sixth aspect.

Thus, output data corresponding to a plurality of items of obtainment data resulting from repeated obtainment during the period from when the ignition switch of the vehicle is turned on to when the ignition switch is turned off is output together at the timing of turning off the ignition switch. Alternatively, output data corresponding to a plurality of items of obtainment data resulting from repeated obtainment during the period from when the processing of the in-vehicle device starts to when the processing ends is output together at the timing of the end of the processing. This can omit the output of output data during the period, and therefore reduce the processing load.

In an in-vehicle device according to an eighth aspect, the outputter may output, for each sampling period set in advance, output data corresponding to a plurality of items of obtainment data obtained in the sampling period. The eighth aspect may be subordinate to any one of the first aspect to the seventh aspect.

Since output data is output periodically, the load for outputting output data once can be reduced compared to, for example, when output data is output together at the end of the processing of the in-vehicle device.

In an in-vehicle device according to a ninth aspect, the obtainment data may indicate at least one of an operation rate of the CPU or a temperature related to the CPU as the operation status of the CPU, and the temperature related to the CPU may include at least one of a temperature of the CPU, an internal temperature of the in-vehicle device, or an external temperature of the vehicle. The ninth aspect may be subordinate to any one of the first aspect to the eighth aspect.

Thus, the obtainment data can appropriately indicate the operation status of the CPU. A higher temperature related to the CPU is considered to represent less margin in the operation status of the CPU. Hence, when the obtainment data indicates the temperature related to the CPU, the operation status of the CPU can be easily understood from the output data based on the obtainment data.

In an in-vehicle device according to a tenth aspect, the obtainment data may indicate a numerical value as the operation status of the CPU, and the extraction condition may be any one of (1) the numerical value being greater than or equal to a first threshold, (2) the numerical value being less than or equal to a second threshold, or (3) the numerical value being within a predetermined range. The tenth aspect may be subordinate to any one of the first aspect to the ninth aspect.

Thus, only representative obtainment data for understanding the operation status of the CPU can be extracted from the plurality of items of obtainment data resulting from repeated obtainment.

In an in-vehicle device according to an eleventh aspect, the obtainment data may indicate the operation rate of the CPU and the temperature related to the CPU, the extraction condition may include a first condition for the operation rate indicated by the obtainment data and a second condition for the temperature indicated by the obtainment data, and the condition determiner may determine that the item of obtainment data satisfies the extraction condition when the operation rate satisfies the first condition and the temperature satisfies the second condition. The eleventh aspect may be subordinate to the ninth aspect, or the tenth aspect subordinate to the ninth aspect.

Thus, only representative obtainment data for understanding the operation status of the CPU in terms of the operation rate and temperature of the CPU can be extracted from the plurality of items of obtainment data resulting from repeated obtainment.

In an in-vehicle device according to a twelfth aspect, the obtainment data may indicate the operation rate of the CPU and the temperature related to the CPU, the condition determiner may determine, for each of the plurality of items of obtainment data resulting from repeatedly obtaining the obtainment data, whether a first numerical value that is one of the operation rate or the temperature indicated by the item of obtainment data satisfies the extraction condition, and the outputter may output, for each of the one or more items of obtainment data determined to satisfy the extraction condition, the output data based on a second numerical value that is an other one of the operation rate or the temperature indicated by the item of obtainment data. The twelfth aspect may be subordinate to the ninth aspect, or the tenth aspect subordinate to the ninth aspect.

Thus, only representative obtainment data for understanding the operation status of the CPU in terms of one of the operation rate or temperature of the CPU can be extracted from the plurality of items of obtainment data resulting from repeated obtainment. Output data for understanding the operation status of the CPU in terms of the other one of the operation rate or temperature of the CPU can then be output.

In an in-vehicle device according to a thirteenth aspect, the outputter may output the output data based on a duration time during which the one or more items of obtainment data determined to satisfy the extraction condition from among the plurality of items of obtainment data are continuously obtained by the obtainer. The thirteenth aspect may be subordinate to any one of the first aspect to the twelfth aspect.

Thus, for example, how long the state in which the operation status of the CPU has little margin continues can be understood from the output data that is output.

An output method according to the first aspect of the present disclosure is an output method executed by an in-vehicle device that is provided in a vehicle and includes a central processing unit (CPU), the output method including: repeatedly obtaining obtainment data indicating at least an operation status of the CPU; determining, for each of a plurality of items of obtainment data resulting from repeatedly obtaining the obtainment data, whether the item of obtainment data satisfies an extraction condition set in advance; and outputting output data based only on one or more items of obtainment data determined to satisfy the extraction condition from among the plurality of items of obtainment data.

This has the same effects as the in-vehicle device according to the first aspect.

A program according to the first aspect of the present disclosure is a program for an in-vehicle device that is provided in a vehicle and includes a central processing unit (CPU), the program causing a computer included in the in-vehicle device to: repeatedly obtain obtainment data indicating at least an operation status of the CPU; determine, for each of a plurality of items of obtainment data resulting from repeatedly obtaining the obtainment data, whether the item of obtainment data satisfies an extraction condition set in advance; and output output data based only on one or more items of obtainment data determined to satisfy the extraction condition from among the plurality of items of obtainment data. The computer is composed of a group of structural elements including the CPU.

This has the same effects as the in-vehicle device according to the first aspect.

An embodiment will be described in detail below, with reference to the drawings.

The embodiment described below shows a general and specific example. The numerical values, shapes, materials, structural elements, the arrangement and connection of the structural elements, steps, the order of steps, etc. shown in the following embodiment are mere examples, and do not limit the scope of the present disclosure. Of the structural elements in the embodiment described below, the structural elements not recited in any one of the independent claims representing the broadest concepts are described as optional structural elements.

Each drawing is a schematic, and does not necessarily provide precise depiction. The same structural elements are given the same reference marks throughout the drawings.

### EMBODIMENT

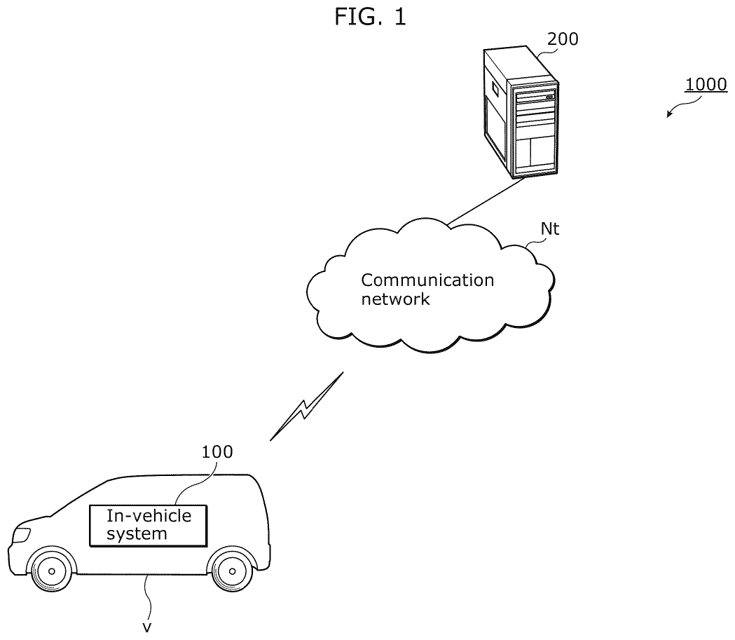

FIG. 1 is a diagram illustrating an example of a communication system in this embodiment.

As illustrated in FIG. 1, communication system 1000 includes in-vehicle system 100 and server 200. In-vehicle system 100 is provided in vehicle V and provides services such as in-vehicle infotainment (IVI) to one or more occupants of vehicle V. In-vehicle system 100 also communicates with server 200 via communication network Nt. An in-vehicle device in this embodiment is included in in-vehicle system 100.

Server 200 provides various information or services to in-vehicle system 100 via communication network Nt. Server 200 also receives various data from in-vehicle system 100 via communication network Nt. Upon receiving output data (described later) from in-vehicle system 100, server 200 can easily understand how much margin there is in the operation status of the CPU in the in-vehicle device included in in-vehicle system 100 based on the output data. When server 200 understands that there is margin in the operation status, server 200 transmits a software program to the in-vehicle device in response to a request from the in-vehicle device and permits the installation of the software program.

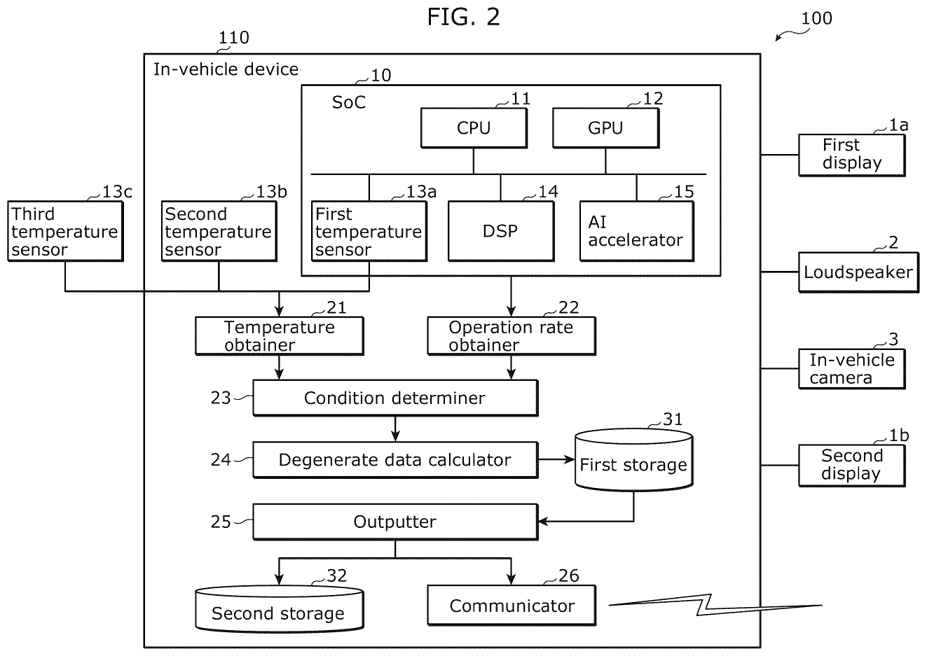

FIG. 2 is a diagram illustrating an example of the structures of in-vehicle system 100 and the in-vehicle device in this embodiment.

As illustrated in FIG. 2, in-vehicle system 100 includes in-vehicle device 110 in this embodiment. In-vehicle system 100 also includes first display 1a, second display 1b, loudspeaker 2, in-vehicle camera 3, and third temperature sensor 13c.

First display 1a is, for example, a display placed on the dashboard or instrument panel of vehicle V. Second display 1b is, for example, a display for displaying images to occupants in the back seats of vehicle V. Loudspeaker 2 is placed in the vehicle interior of vehicle V and outputs audio to the occupants of vehicle V. In-vehicle camera 3 is, for example, a camera that captures images of the surroundings of vehicle V and outputs an imaging signal obtained by capturing the images. In-vehicle camera 3 may also be used for a dashboard camera, advanced driver-assistance systems (ADAS), etc. Third temperature sensor 13c measures the temperature around the outside of vehicle V and outputs external temperature data indicating the measured temperature as the external temperature.

In-vehicle device 110 in this embodiment is, for example, an electronic control unit (ECU), and receives external temperature data from third temperature sensor 13c and an imaging signal from in-vehicle camera 3. In-vehicle device 110 outputs signals indicating video or audio to first display 1a, second display 1b, and loudspeaker 2, for example, to provide services to the occupants of vehicle V.

In-vehicle device 110 includes system on a chip (SoC) 10, second temperature sensor 13b, temperature obtainer 21, operation rate obtainer 22, condition determiner 23, degenerate data calculator 24, outputter 25, second storage 32, communicator 26, and first storage 31.

SoC 10 controls, for example, one or more structural elements included in in-vehicle system 100 other than SoC 10. SoC 10 includes CPU 11, graphics processing unit (GPU) 12, first temperature sensor 13a, digital signal processor (DSP) 14, and artificial intelligence (AI) accelerator 15. CPU 11 is a processor that controls one or more structural elements included in in-vehicle device 110 other than CPU 11. GPU 12 is a processor that processes images or video displayed on at least one of first display 1a or second display 1b. First temperature sensor 13a measures the temperature of CPU 11 and outputs CPU temperature data indicating the measured temperature as the CPU temperature. DSP 14 is a processor that processes digital signals to provide each service by in-vehicle system 100. AI accelerator 15 is a processor that accelerates processing using machine learning such as a neural network used to provide each service by in-vehicle system 100.

Second temperature sensor 13b measures the temperature inside in-vehicle device 110 and outputs internal temperature data indicating the measured temperature as the internal temperature.

Temperature obtainer 21 obtains, for example periodically, the CPU temperature data output from first temperature sensor 13a, the internal temperature data output from second temperature sensor 13b, and the external temperature data output from third temperature sensor 13c. Temperature obtainer 21 then outputs temperature data indicating the CPU temperature indicated by the CPU temperature data, the internal temperature indicated by the internal temperature data, and the external temperature indicated by the external temperature data to condition determiner 23. The CPU temperature, the internal temperature, and the external temperature can be regarded as indicating the operation status of CPU 11. The temperature data is also referred to as obtainment data.

Temperature obtainer 21 may select one or two temperatures out of the CPU temperature, the internal temperature, and the external temperature, and output temperature data indicating the selected one or two temperatures to condition determiner 23. The selected one or two temperatures may be changed by a selection operation by the user. In other words, the temperature data indicates at least one of the temperature of CPU 11, the temperature inside in-vehicle device 110, or the temperature outside vehicle V as a temperature related to CPU 11. Temperature obtainer 21 may calculate a characteristic temperature from the internal temperature, the external temperature, and the CPU temperature, and output temperature data indicating the calculated temperature. The characteristic temperature may be a temperature calculated by subtracting, from any one temperature out of the internal temperature, the external temperature, and the CPU temperature, another temperature out of the internal temperature, the external temperature, and the CPU temperature. For example, the characteristic temperature may be a temperature obtained by subtracting the external temperature or the internal temperature from the CPU temperature.

Operation rate obtainer 22 obtains the operation rate of CPU 11, for example periodically. The operation rate of CPU 11 can be regarded as indicating the operation status of CPU 11. The operation rate is a numerical value indicating how much of entire CPU 11 is in an operating state, and is expressed as a percentage, for example. For example, a higher operation rate of CPU 11 indicates that CPU 11 performs more processing and has less available capacity. Operation rate obtainer 22 outputs operation data indicating the operation rate to condition determiner 23. The operation data is also referred to as obtainment data.

In other words, temperature obtainer 21 and operation rate obtainer 22 in this embodiment are an obtainer that repeatedly obtains obtainment data indicating at least the operation status of CPU 11. Specifically, in this embodiment, the obtainer including temperature obtainer 21 and operation rate obtainer 22 periodically obtains obtainment data including temperature data and operation data. Thus, the obtainment data in this embodiment indicates the operation rate of CPU 11 and the temperature related to CPU 11. The cycle with which the obtainment data is obtained may be, for example, one second. The cycle is not limited to one second and may be any other time period and may be changeable.

Condition determiner 23 determines, for each of a plurality of items of obtainment data resulting from repeatedly obtaining the obtainment data, whether the item of obtainment data satisfies an extraction condition set in advance. In detail, each time temperature obtainer 21 and operation rate obtainer 22 obtain obtainment data, condition determiner 23 receives the obtainment data from temperature obtainer 21 and operation rate obtainer 22. For each of a plurality of items of obtainment data resulting from repeatedly obtaining the obtainment data, condition determiner 23 determines whether operation data included in the item of obtainment data and temperature data included in the item of obtainment data satisfy the extraction condition. When condition determiner 23 determines that the operation data and temperature data included in the item of obtainment data satisfy the extraction condition, that is, when condition determiner 23 determines that the item of obtainment data satisfies the extraction condition, condition determiner 23 outputs the item of obtainment data to degenerate data calculator 24. In other words, condition determiner 23 extracts only each item of obtainment data determined to satisfy the extraction condition from the plurality of items of obtainment data resulting from repeated obtainment, and outputs the extracted item of obtainment data to degenerate data calculator 24.

Degenerate data calculator 24 obtains, for example, two or more items of obtainment data that satisfy the extraction condition from condition determiner 23. Degenerate data calculator 24 then calculates degenerate data from the two or more items of obtainment data. The amount of degenerate data is less than the total amount of the two or more items of obtainment data. In detail, when condition determiner 23 determines that two or more items of obtainment data satisfy the extraction condition from among the plurality of items of obtainment data resulting from repeated obtainment, degenerate data calculator 24 in this embodiment calculates, from the two or more items of obtainment data determined to satisfy the extraction condition, degenerate data that is smaller in data amount than the total of the two or more items of obtainment data. In other words, degenerate data calculator 24 calculates the degenerate data by degenerating the two or more items of obtainment data. Here, each of the two or more items of obtainment data indicates a temperature and operation rate as a numerical value. Thus, each of the two or more items of obtainment data determined to satisfy the extraction condition indicates a numerical value as the operation status of CPU 11. The degenerate data indicates, for example, the largest value, smallest value, mode value, median value, average value, or histogram of the numerical values indicated by the two or more items of obtainment data. The numerical value may be any of the CPU temperature, the internal temperature, the external temperature, and the operation rate of CPU 11.

Degenerate data calculator 24 stores the degenerate data calculated in this manner in first storage 31. Specifically, each time degenerate data calculator 24 obtains an item of obtainment data that satisfies the extraction condition from condition determiner 23 as extracted obtainment data, degenerate data calculator 24 updates the degenerate data stored in first storage 31 using the obtained item of extracted obtainment data and one or more items of extracted obtainment data obtained previously. If no degenerate data is stored in first storage 31, degenerate data calculator 24 stores the calculated degenerate data in first storage 31. The degenerate data moved from first storage 31 is treated as output data (described later).

First storage 31 and second storage 32 are recording media for storing output data. First storage 31 is used to temporarily store the latest degenerate data as output data. Second storage 32 is used to store output data for a longer period of time than first storage 31. First storage 31 and second storage 32 are each a hard disk drive, random access memory (RAM), read only memory (ROM), semiconductor memory, or the like. First storage 31 and second storage 32 may be volatile or non-volatile. Alternatively, first storage 31 may be volatile and second storage 32 non-volatile. Communicator 26 communicates with server 200 outside vehicle V via communication network Nt.

Outputter 25 outputs output data based only on two or more items of obtainment data determined to satisfy the extraction condition from among the plurality of items of obtainment data resulting from repeated obtainment by temperature obtainer 21 and operation rate obtainer 22. The output data based only on the two or more items of obtainment data determined to satisfy the extraction condition is the degenerate data stored in first storage 31. In other words, outputter 25 reads the degenerate data stored in first storage 31 and outputs the degenerate data as the output data. Specifically, outputter 25 outputs the output data by reading the output data from first storage 31 and storing it in second storage 32. The degenerate data stored in first storage 31 is updated successively by degenerate data calculator 24, and the latest degenerate data is transferred to second storage 32 as the output data. Moreover, outputter 25 outputs the output data by causing communicator 26 to transmit the output data stored in first storage 31 to server 200. The output data is thus transmitted from communicator 26 to server 200.

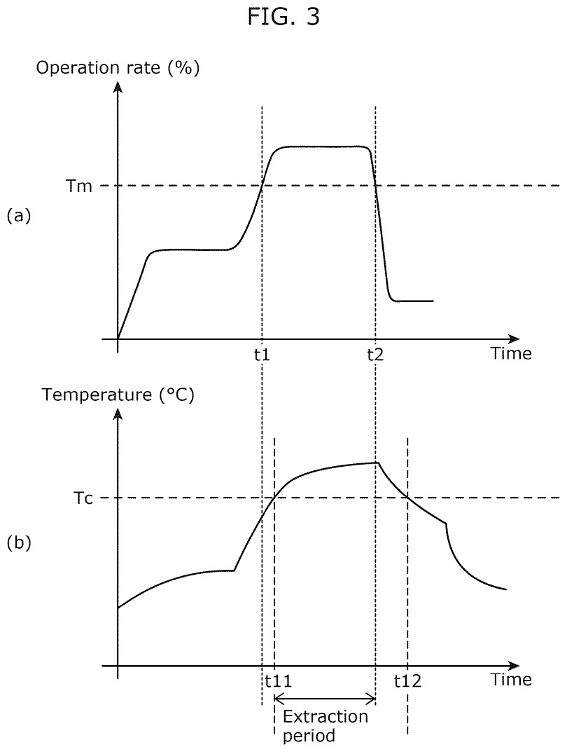

FIG. 3 is a diagram for explaining the process operation of condition determiner 23. (a) in FIG. 3 is a graph illustrating the relationship between the operation rate of CPU 11 indicated by the operation data and time, with the vertical axis representing the operation rate and the horizontal axis representing the time. (b) in FIG. 3 is a graph illustrating the relationship between the temperature indicated by the temperature data and time, with the vertical axis representing the temperature and the horizontal axis representing the time. The temperature may be any of the CPU temperature, the internal temperature, and the external temperature.

The extraction condition includes a first condition for the operation rate indicated by the operation data included in the obtainment data and a second condition for the temperature indicated by the temperature data included in the obtainment data. Condition determiner 23 determines that the obtainment data satisfies the extraction condition when the operation rate satisfies the first condition and the temperature satisfies the second condition. For example, the first condition is that the operation rate is greater than or equal to threshold Tm, and the second condition is that the temperature is greater than or equal to threshold Tc.

Specifically, the operation rate of CPU 11 indicated by the periodically obtained operation data changes over time, as illustrated in (a) in FIG. 3. The operation rate is greater than or equal to threshold Tm during the period from time t1 to time t2. In this case, condition determiner 23 determines that the operation data (i.e. operation rate) satisfies the first condition during the period from time t1 to time t2.

Moreover, the temperature indicated by the periodically obtained temperature data changes over time, as illustrated in (b) in FIG. 3. The temperature is greater than or equal to threshold Tc during the period from time t11 to time t12. In this case, condition determiner 23 determines that the temperature data (i.e. temperature) satisfies the second condition during the period from time t11 to time t12.

Here, time t11 is after time t1 and before time t2, and time t12 is after time t2. Therefore, the operation rate satisfies the first condition and the temperature satisfies the second condition during the period from time t11 to time t2. Condition determiner 23 accordingly determines that the obtainment data obtained by temperature obtainer 21 and operation rate obtainer 22 during the extraction period, which is the period from time t11 to time t2, satisfies the extraction condition. Consequently, condition determiner 23 extracts only each item of obtainment data during the extraction period from among the plurality of items of obtainment data periodically obtained by temperature obtainer 21 and operation rate obtainer 22, and outputs the item of obtainment data to degenerate data calculator 24.

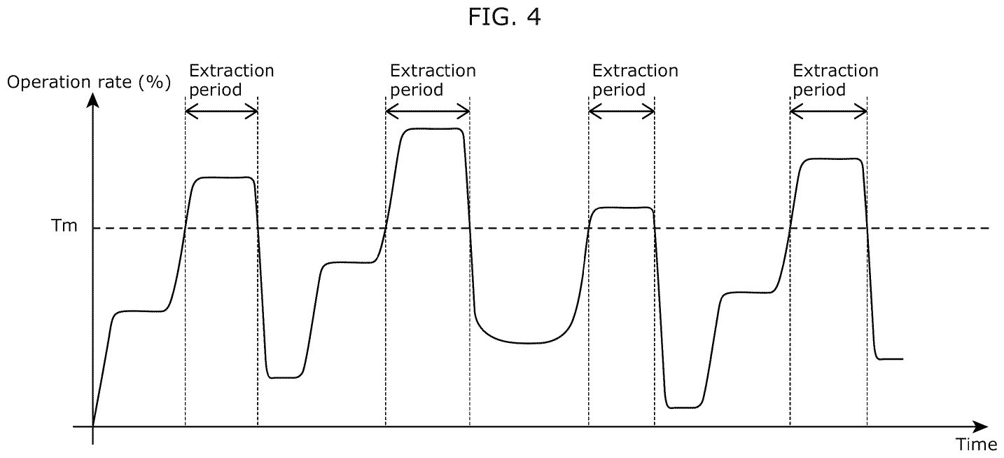

FIG. 4 is a diagram for explaining the process operation of degenerate data calculator 24. FIG. 4 is a graph illustrating the relationship between the operation rate of CPU 11 indicated by the operation data and time, with the vertical axis representing the operation rate and the horizontal axis illustrating the time.

In the example illustrated in FIG. 4, the operation rate is greater than or equal to threshold Tm in each of a plurality of periods. If the temperature is greater than or equal to threshold Tc during each of these periods, the period is treated as an extraction period. In this case, degenerate data calculator 24 obtains the operation data obtained by operation rate obtainer 22 in each of the plurality of extraction periods from condition determiner 23, as illustrated in FIG. 4.

Degenerate data calculator 24 may calculate degenerate data for each of the extraction periods. For example, degenerate data calculator 24 calculates, for each extraction period, degenerate data indicating the largest value, smallest value, median value, mode value, or average value of the operation rates indicated by the plurality of items of operation data obtained during the extraction period.

Thus, degenerate data calculator 24 calculates, for each extraction period, degenerate data based on two or more items of obtainment data (operation data in the above example) obtained by the obtainer during the extraction period. The extraction period is a period during which the obtainment data satisfying the condition extraction is repeatedly and continuously obtained by the obtainer. Thus, degenerate data is calculated for each extraction period, so that the accuracy of the operation status of CPU 11 indicated by degenerate data can be enhanced compared to when one item of degenerate data is calculated for a plurality of extraction periods.

Alternatively, degenerate data calculator 24 may calculate degenerate data for the entire plurality of extraction periods. For example, degenerate data calculator 24 calculates degenerate data indicating the largest value, smallest value, median value, mode value, or average value of the operation rates indicated by the plurality of items of operation data obtained during the plurality of extraction periods.

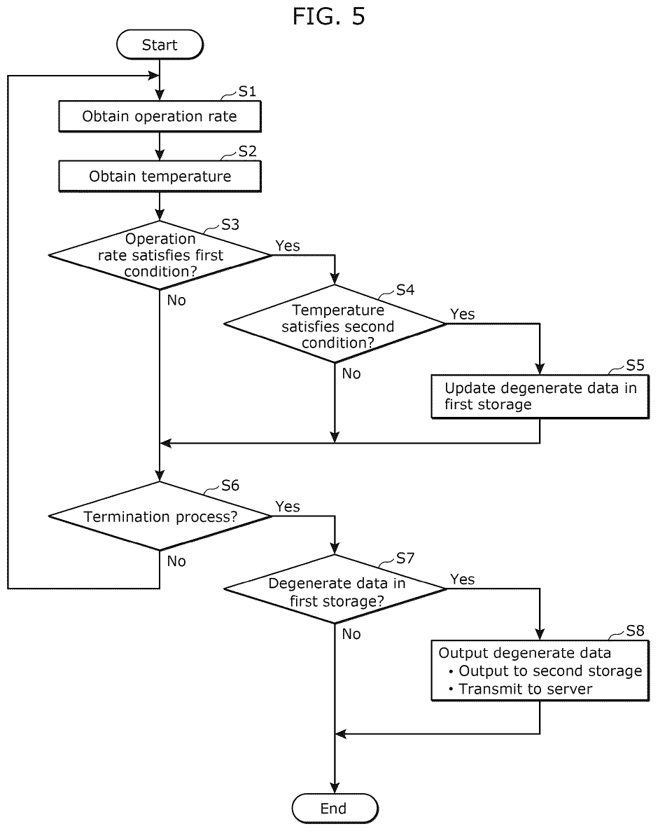

FIG. 5 is a flowchart illustrating an example of the process operation of in-vehicle device 110 in this embodiment.

First, operation rate obtainer 22 obtains the operation rate of CPU 11 at a timing according to a predetermined cycle (Step S1). That is, operation rate obtainer 22 obtains operation data and outputs the operation data to condition determiner 23. Next, temperature obtainer 21 obtains the temperature at the foregoing timing (Step S2). That is, temperature obtainer 21 obtains temperature data and outputs the temperature data to condition determiner 23. The operation data and temperature data obtained in Steps S1 and S2 are data included in the above-described obtainment data.

Next, condition determiner 23 determines whether the operation rate obtained in Step S1 satisfies the first condition (Step S3). When condition determiner 23 determines that the operation rate satisfies the first condition (Step S3: Yes), condition determiner 23 further determines whether the temperature obtained in Step S2 satisfies the second condition (Step S4). When condition determiner 23 determines that the temperature satisfies the second condition (Step S4: Yes), condition determiner 23 determines that the obtainment data obtained in Steps S1 and S2 satisfies the extraction condition, and outputs the obtainment data to degenerate data calculator 24.

Having obtained the obtainment data from condition determiner 23, degenerate data calculator 24 updates the degenerate data in first storage 31 using the obtainment data (Step S5). For example, degenerate data calculator 24 calculates degenerate data indicating the largest value, smallest value, median value, average value, or the like of the latest operation rate and one or more past operation rates. The latest operation rate is the operation rate indicated by the operation data included in the obtainment data obtained most recently. The past operation rates are each the operation rate indicated by the operation data included in past obtainment data obtained before the most recent obtainment data. Degenerate data calculator 24 updates the degenerate data stored in first storage 31 using the calculated degenerate data.

When condition determiner 23 determines that the operation rate does not satisfy the first condition in Step S3 (Step S3: No), outputter 25 determines whether in-vehicle device 110 is in a termination process (Step S6). When condition determiner 23 determines that the temperature does not satisfy the second condition in Step S4 (Step S4: No), outputter 25 determines whether in-vehicle device 110 is in the termination process (Step S6). Alternatively, after the process of Step S5, outputter 25 determines whether in-vehicle device 110 is in the termination process (Step S6). The termination process of in-vehicle device 110 is, for example, a process for terminating all processes of in-vehicle device 110 or a process for turning off in-vehicle device 110. The termination process may be performed when the ignition switch of vehicle V is turned off.

When outputter 25 determines that in-vehicle device 110 is not in the termination process (Step S6: No), in-vehicle device 110 repeats the processes from Step S1. When outputter 25 determines that in-vehicle device 110 is in the termination process (Step S6: Yes), outputter 25 determines whether degenerate data is stored in first storage 31 (Step S7). When outputter 25 determines that degenerate data is stored in first storage 31 (Step S7: Yes), outputter 25 outputs the stored degenerate data as output data (Step S8). In detail, outputter 25 transfers the output data from first storage 31 to second storage 32 by outputting the output data to second storage 32. The output data is thus stored in second storage 32. Here, the output data may be deleted from first storage 31. Outputter 25 further outputs the output data to communicator 26 to cause communicator 26 to transmit the output data to server 200.

In this way, outputter 25 outputs output data when the ignition switch of vehicle V is turned off or when the processing of in-vehicle device 110 ends. Thus, output data corresponding to a plurality of items of obtainment data resulting from repeated obtainment during the period from when the ignition switch of vehicle V is turned on to when the ignition switch is turned off is output together at the timing of turning off the ignition switch. Alternatively, output data corresponding to a plurality of items of obtainment data resulting from repeated obtainment during the period from when the processing of in-vehicle device 110 starts to when the processing ends is output together at the timing of the end of the processing. This can omit the output of output data during the period, and therefore reduce the processing load.

When outputter 25 determines that degenerate data is not stored in first storage 31 (Step S7: No) or after the process of Step S8, in-vehicle device 110 ends all processing.

Thus, in this embodiment, the output data based on the obtainment data indicating at least the operation status of CPU 11 is output, so that the operation status of CPU 11 can be easily understood from the output data. Therefore, for example, when server 200 receives the output data, server 200 can understand the operation status of CPU 11 and easily know how much margin the operation status of CPU 11 has, and can appropriately determine whether it is okay to install a software program on in-vehicle device 110. Since the output data that is output is based only on two or more items of obtainment data determined to satisfy the extraction condition from among the plurality of items of obtainment data resulting from repeatedly obtaining the obtainment data, the amount of output data that is output can be reduced compared to when all items of obtainment data resulting from repeatedly obtaining the obtainment data are output as output data. Accordingly, the amount of output data that is output can be reduced while enabling easy understanding of the operation status of CPU 11 from the output data.

In this embodiment, outputter 25 outputs the output data by causing communicator 26 to transmit the output data to server 200. Thus, server 200 can receive the output data. As a result, server 200 can understand the operation status of CPU 11 in in-vehicle device 110 and easily know how much margin the operation status of CPU 11 has, and can appropriately determine whether it is okay to install a software program on in-vehicle device 110.

In this embodiment, outputter 25 outputs the output data by reading the output data from first storage 31 and storing the output data in second storage 32. Thus, the output data can be saved in second storage 32. The output data can then be read from second storage 32 at any time, and the operation status of CPU 11 can be easily understood based on the output data. In this embodiment, degenerate data is calculated from two or more items of obtainment data determined to satisfy the extraction condition. Thus, the degenerate data that is smaller in data amount than the total of the two or more items of obtainment data determined to satisfy the extraction condition is output as output data. In this way, the amount of output data can be reduced compared to when the two or more items of obtainment data determined to satisfy the extraction condition are output as output data.

In this embodiment, the degenerate data indicates the largest value, smallest value, mode value, median value, average value, or histogram of the numerical values indicated by the two or more items of obtainment data. Thus, the amount of degenerate data can be reduced while the degenerate data appropriately indicates the operation status of CPU 11 indicated by each of the two or more items of obtainment data. The amount of output data that is output can therefore be reduced effectively.

In this embodiment, condition determiner 23 determines that the obtainment data indicating the operation rate and the temperature satisfies the extraction condition when the operation rate satisfies a first condition and the temperature satisfies a second condition. Thus, only representative obtainment data for understanding the operation status of CPU 11 in terms of the operation rate and temperature of CPU 11 can be extracted from the plurality of items of obtainment data resulting from repeated obtainment.

### (Variation 1)

In the above embodiment, outputter 25 outputs output data when in-vehicle device 110 is in the termination process. In this variation, outputter 25 outputs output data at the end of each sampling period. For example, the sampling period is 10 minutes. The sampling period is not limited to 10 minutes, and may be any time period and may be changeable.

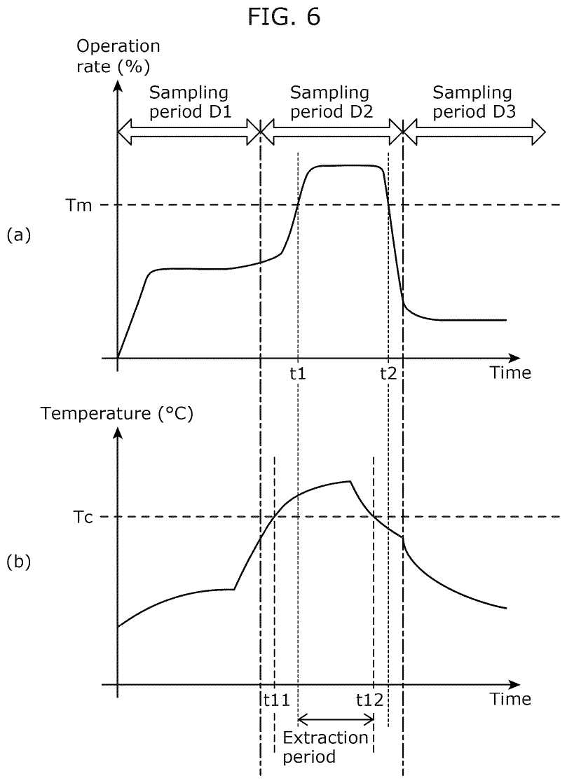

FIG. 6 is a diagram for explaining the process operation of outputter 25 and condition determiner 23 in this variation. (a) in FIG. 6 is a graph illustrating the relationship between the operation rate of CPU 11 indicated by the operation data and time, with the vertical axis representing the operation rate and the horizontal axis representing the time. (b) in FIG. 6 is a graph illustrating the relationship between the temperature indicated by the temperature data and time, with the vertical axis representing the temperature and the horizontal axis representing the time. The temperature may be any of the CPU temperature, the internal temperature, and the external temperature.

The extraction condition includes a first condition and a second condition, as in the above embodiment. For example, the first condition is that the operation rate of CPU 11 is greater than or equal to threshold Tm, and the second condition is that the temperature is greater than or equal to threshold Tc.

The operation rate of CPU 11 indicated by the periodically obtained operation data changes over time, as illustrated in (a) in FIG. 6. The operation rate is less than threshold Tm during sampling period D1, may be greater than threshold Tm during next sampling period D2, and is less than threshold Tm during next sampling period D3. In sampling period D2, the operation rate is greater than or equal to threshold Tm during the period from time t1 to time t2. In this case, condition determiner 23 determines that the operation data (i.e. operation rate) satisfies the first condition during the period from time t1 to time t2.

Moreover, the temperature indicated by the periodically obtained temperature data changes over time, as illustrated in (b) in FIG. 6. The temperature is less than threshold Tc during sampling period D1, may be greater than threshold Tc during next sampling period D2, and is less than threshold Tc during next sampling period D3. In sampling period D2, the temperature is greater than or equal to threshold Tc during the period from time t11 to time t12. In this case, condition determiner 23 determines that the temperature data (i.e. temperature) satisfies the second condition during the period from time t11 to time t12.

In the example in FIG. 6, time t11 is before time t1, and time t12 is after time t1 and before time t2. Therefore, the operation rate satisfies the first condition and the temperature satisfies the second condition during the period from time t1 to time t12. Condition determiner 23 accordingly determines that the obtainment data obtained by temperature obtainer 21 and operation rate obtainer 22 during the extraction period, which is the period from time t1 to time t12, satisfies the extraction condition. Consequently, condition determiner 23 extracts only each item of obtainment data during the extraction period from among the plurality of items of obtainment data periodically obtained by temperature obtainer 21 and operation rate obtainer 22, and outputs the item of obtainment data to degenerate data calculator 24. Each time degenerate data calculator 24 receives extracted obtainment data from condition determiner 23, degenerate data calculator 24 updates the degenerate data stored in first storage 31 using the extracted obtainment data. If no degenerate data is stored in first storage 31, degenerate data calculator 24 stores the calculated degenerate data in first storage 31.

Thus, outputter 25 does not output output data at the end time of sampling period D1 and the end time of sampling period D3, because no degenerate data is stored in first storage 31. Meanwhile, at the end time of sampling period D2 which includes the foregoing extraction period, outputter 25 outputs the degenerate data as output data because the degenerate data is stored in first storage 31.

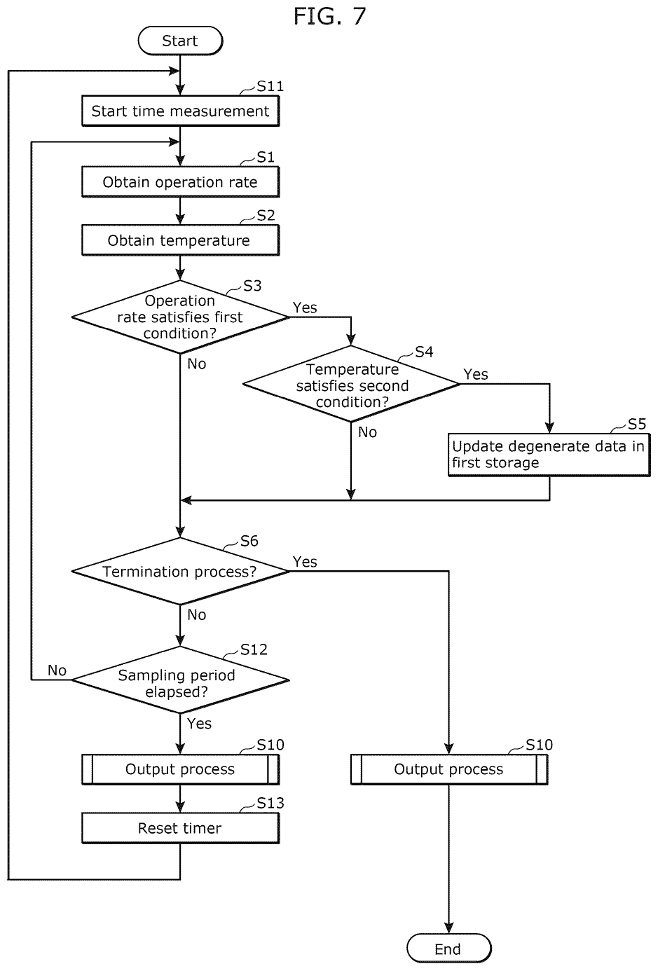

FIG. 7 is a flowchart illustrating an example of the process operation of in-vehicle device 110 in this variation. The flowchart illustrated in FIG. 7 includes the processes of Steps S1 to S8 included in the flowchart illustrated in FIG. 5, and further includes the processes of Steps S11 to S13. In FIG. 7, Steps S7 and S8 in FIG. 5 are illustrated as the output process of Step S10.

First, outputter 25 starts time measurement (Step S11). In other words, outputter 25 starts a timer. In-vehicle device 110 executes the processes of Steps S1 to S6 and S10 as in the above embodiment.

In this variation, when outputter 25 determines that in-vehicle device 110 is not in the termination process in Step S6 (Step S6: No), in-vehicle device 110 executes the process of Step S12 without repeating the processes from Step S1. In detail, outputter 25 determines whether a sampling period has elapsed from the start of time measurement in most recent Step S11 (Step S12). When outputter 25 determines that the sampling period has elapsed (Step S12: Yes), outputter 25 executes an output process (Step S10). In detail, outputter 25 executes the processes of Steps S7 and S8 illustrated in FIG. 5. After the output process of Step S10, outputter 25 resets the timer used for measuring time (Step S13) and repeats the processes from Step S11. When outputter 25 determines that the sampling period has not elapsed (Step S12: No), in-vehicle device 110 repeats the processes from Step S1.

In this variation, outputter 25 outputs, for each sampling period set in advance, output data corresponding to a plurality of items of obtainment data obtained in the sampling period. Since output data is output periodically, the load for outputting output data once can be reduced compared to, for example, when output data is output together at the end of the processing of in-vehicle device 110.

### (Variation 2)

In the above embodiment, outputter 25 outputs output data when in-vehicle device 110 is in the termination process. In this variation, outputter 25 outputs output data at the end of each extraction period.

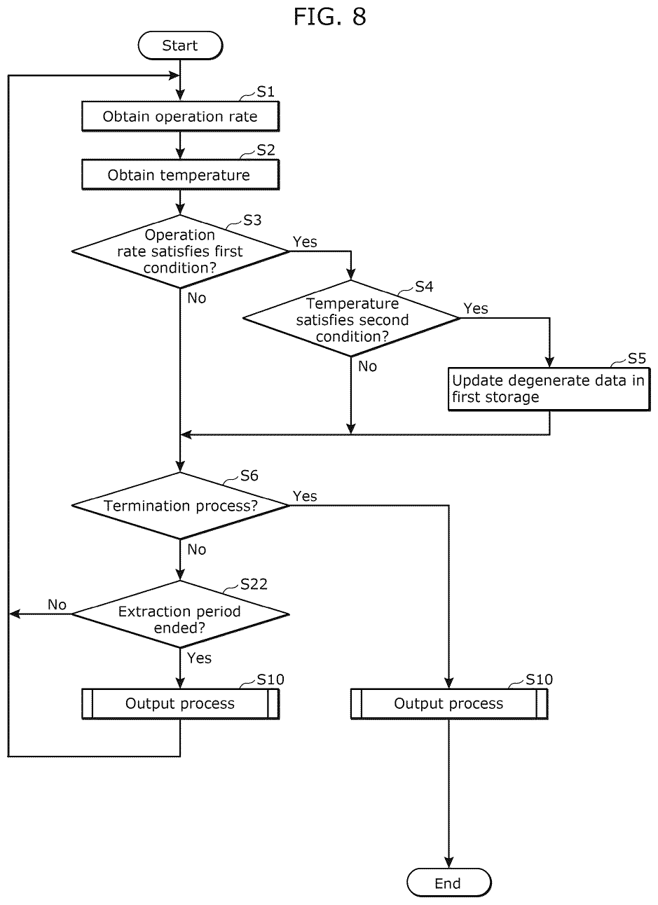

FIG. 8 is a flowchart illustrating an example of the process operation of in-vehicle device 110 in this variation. The flowchart illustrated in FIG. 8 includes the processes of Steps S1 to S8 included in the flowchart illustrated in FIG. 5, and further includes the process of Step S22. In FIG. 8, Steps S7 and S8 in FIG. 5 are illustrated as the output process of Step S10.

First, in-vehicle device 110 executes the processes of Steps S1 to S6 and S10 as in the above embodiment. In this variation, when outputter 25 determines that in-vehicle device 110 is not in the termination process in Step S6 (Step S6: No), in-vehicle device 110 executes the process of Step S22 without repeating the processes from Step S1. In detail, outputter 25 determines whether the extraction period has ended (Step S22). Specifically, outputter 25 determines that the extraction period has ended when a cycle in which the process of Step S5 is not performed occurs immediately after one or more consecutive cycles in which the process of Step S5 is performed. Here, the “cycle” refers to a cycle in which the processes of Steps S1 to S6 are repeatedly performed. The case where a cycle in which the process of Step S5 is not performed occurs is when it is determined in the process of Step S3 immediately before Step S22 that the operation rate does not satisfy the first condition (Step S3: No) or when it is determined in the process of Step S4 immediately before Step S22 that the temperature does not satisfy the second condition (Step S4: No).

When outputter 25 determines that the extraction period has ended (Step S22: Yes), outputter 25 executes the output process (Step S10). In other words, outputter 25 executes the processes of Steps S7 and S8 illustrated in FIG. 5. After the output process of Step S10, in-vehicle device 110 repeats the processes from Step S1. When outputter 25 determines that the extraction period has not ended (Step S22: No), in-vehicle device 110 repeats the processes from Step S1. In Step S22, when the extraction period has not started, outputter 25 determines that the extraction period has not ended.

In Variation 2, the same effects as in Variation 1 can be achieved.

### (Variation 3)

The extraction condition in the above embodiment includes the first condition and the second condition. The first condition is that the operation rate of CPU 11 is greater than or equal to threshold Tm, and the second condition is that the temperature is greater than or equal to threshold Tc. The extraction condition is not limited to such first and second conditions, and other conditions may be used.

In the above embodiment, the operation rate of CPU 11 or the temperature indicated by the extracted obtainment data is used to calculate the degenerate data. However, the numerical value (i.e. degeneration target) used to calculate the degenerate data is not limited to the operation rate of CPU 11 or the temperature, and may be a duration time. The duration time is the time during which the operation rate of CPU 11 or the temperature continues to satisfy the extraction condition. The degenerate data calculated from such a duration time is output as output data. In other words, outputter 25 may output output data based on the duration time during which one or more items of obtainment data determined to satisfy the extraction condition from among the plurality of items of obtainment data are continuously obtained by the obtainer. Thus, for example, how long the state in which the operation status of CPU 11 has little margin continues can be understood from the output data that is output.

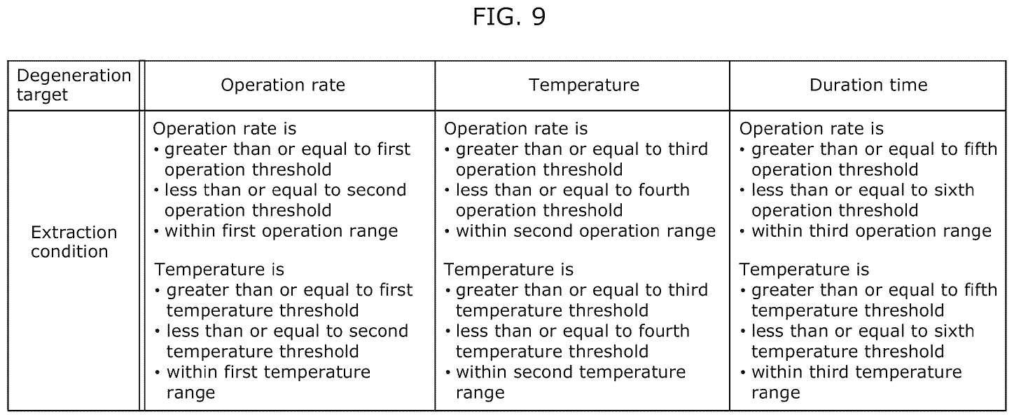

FIG. 9 is a diagram illustrating some examples of degeneration targets and extraction conditions.

The numerical value used to calculate the degenerate data, which is the degeneration target, may be any of the operation rate of CPU 11, the temperature, and the duration time, as mentioned above.

When the degeneration target is the operation rate, the extraction condition may be either an operation rate condition or a temperature condition, or a combination of an operation rate condition and a temperature condition. The operation rate condition may be a condition that the operation rate is greater than or equal to a first operation threshold, a condition that the operation rate is less than or equal to a second operation threshold, or a condition that the operation rate is within a first operation range. The temperature condition may be a condition that the temperature is greater than or equal to a first temperature threshold, a condition that the temperature is less than or equal to a second temperature threshold, or a condition that the temperature is within a first temperature range.

When the degeneration target is the temperature, the extraction condition may be either an operation rate condition or a temperature condition, or a combination of an operation rate condition and a temperature condition. The operation rate condition may be a condition that the operation rate is greater than or equal to a third operation threshold, a condition that the operation rate is less than or equal to a fourth operation threshold, or a condition that the operation rate is within a second operation range. The temperature condition may be a condition that the temperature is greater than or equal to a third temperature threshold, a condition that the temperature is less than or equal to a fourth temperature threshold, or a condition that the temperature is within a second temperature range. When the degeneration target is the duration time, the extraction condition may be either an operation rate condition or a temperature condition, or a combination of an operation rate condition and a temperature condition. The operation rate condition may be a condition that the operation rate is greater than or equal to a fifth operation threshold, a condition that the operation rate is less than or equal to a sixth operation threshold, or a condition that the operation rate is within a third operation range. The temperature condition may be a condition that the temperature is greater than or equal to a fifth temperature threshold, a condition that the temperature is less than or equal to a sixth temperature threshold, or a condition that the temperature is within a third temperature range.

The first, third, and fifth operation thresholds correspond to, for example, threshold Tm in the above embodiment. The first, third, and fifth temperature thresholds correspond to, for example, threshold Tc in the above embodiment.

In this variation, the obtainment data indicates a numerical value as the operation status of CPU 11, and the extraction condition is any one of (1) the numerical value being greater than or equal to a first threshold, (2) the numerical value being less than or equal to a second threshold, or (3) the numerical value being within a predetermined range. The numerical value is the operation rate of CPU 11 or the temperature, for example. Thus, only representative obtainment data for understanding the operation status of CPU 11 can be extracted from the plurality of items of obtainment data resulting from repeated obtainment.

The degeneration target may be at least one of the operation rate, the temperature, or the duration. The obtainment data may include only one of the operation data or the temperature data. That is, the obtainment data may indicate at least one of the operation rate of CPU 11 or the temperature related to CPU 11 as the operation status of the CPU. The temperature related to CPU 11 includes at least one of the temperature of CPU 11, the internal temperature of in-vehicle device 110, or the external temperature of vehicle V. Thus, the obtainment data can appropriately indicate the operation status of CPU 11. A higher temperature related to CPU 11 is considered to represent less margin in the operation status of CPU 11. Hence, when the obtainment data indicates the temperature related to CPU 11, the operation status of CPU 11 can be easily understood from the output data based on the obtainment data.

The degeneration targets, extraction conditions, thresholds, ranges, etc. illustrated in FIG. 9 may be set for each user, each OEM, or each country or region in which in-vehicle device 110 is located, and may be changed after in-vehicle device 110 is provided in vehicle V.

In the above embodiment, when the operation rate of CPU 11 indicated by the obtainment data satisfies the operation rate condition (i.e. the first condition) and the temperature indicated by the obtainment data satisfies the temperature condition (i.e. the second condition), the obtainment data is determined to satisfy the extraction condition. Here, the extraction condition is a combination of the operation rate condition and the temperature condition. The obtainment data is then extracted as extracted obtainment data, and at least one of the operation rate or the temperature indicated by the extracted obtainment data is used as the degeneration target to update or calculate the degenerate data.

In this variation, on the other hand, when one of the operation rate of CPU 11 or the temperature indicated by the obtainment data satisfies the condition corresponding to it (i.e. the extraction condition), the other one of the operation rate of CPU 11 or the temperature may be used as the degeneration target to update or calculate the degenerate data. In detail, in this variation, the obtainment data indicates the operation rate of CPU 11 and the temperature related to CPU 11. Condition determiner 23 determines, for each of the plurality of items of obtainment data resulting from repeatedly obtaining the obtainment data, whether a first numerical value that is one of the operation rate or the temperature indicated by the item of obtainment data satisfies the extraction condition. Outputter 25 outputs, for each of the one or more items of obtainment data determined to satisfy the extraction condition, the output data based on a second numerical value that is the other one of the operation rate or the temperature indicated by the item of obtainment data. For example, if the first numerical value is the operation rate, the second numerical value is the temperature, the extraction condition is the first condition described above, and the degenerate data of the temperature is output as output data. Alternatively, if the first numerical value is the temperature, the second numerical value is the operation rate, the extraction condition is the second condition described above, and the degenerate data of the operation rate is output as the output data. Thus, only representative obtainment data for understanding the operation status of CPU 11 in terms of one of the operation rate or temperature of CPU 11 can be extracted from the plurality of items of obtainment data resulting from repeated obtainment. Output data for understanding the operation status of CPU 11 in terms of the other one of the operation rate or temperature of CPU 11 can then be output.

### (Other Variations)

The in-vehicle device according to the present disclosure has been described above based on the above embodiment and variations, but the present disclosure is not limited to the above embodiment and variations. Modifications obtained by applying various changes conceivable by a person skilled in the art to any of the above embodiment and variations may also be included in the scope of the present disclosure, without departing from the scope of the present disclosure.

For example, although in-vehicle device 110 includes second storage 32 and communicator 26 in the above embodiment and variations, in-vehicle device 110 may include only either second storage 32 or communicator 26. In other words, outputter 25 may perform only either storing the output data in second storage 32 or transmitting the output data to server 200.

Although in-vehicle device 110 includes degenerate data calculator 24 in the above embodiment and variations, in-vehicle device 110 may not include degenerate data calculator 24. In this case, outputter 25 may output the obtainment data that satisfies the extraction condition (i.e. extracted obtainment data) as output data without degeneration. Thus, one item of extracted obtainment data may be treated as one item of output data. In other words, outputter 25 according to the present disclosure outputs output data based only on one or more items of obtainment data determined to satisfy the extraction condition from among a plurality of items of obtainment data resulting from repeated obtainment. Here, if the extracted obtainment data includes operation data and temperature data, outputter 25 may output only one of the operation data or the temperature data included in the extracted obtainment data as output data.

The degenerate data may indicate a histogram in the above embodiment and variations. Here, the number of bins, the thresholds (i.e. interval), etc. used to form the histogram are changeable by the user, for example.

The sampling period in Variation 1 of the embodiment and the thresholds in Variation 3 of the embodiment may be changed by server 200, or may be changed by the user's input operation to in-vehicle device 110. The sampling period may be automatically changed by in-vehicle device 110.

Although outputter 25 executes the output process (Step S10) upon determining that in-vehicle device 110 is in the termination process in Step S6 (Step S6: Yes) in Variation 1 of the embodiment, the output process may be omitted. In this case, if the driving time of vehicle V is less than the sampling period, the output process is not executed. There is thus a possibility that the output data is not output when the user of vehicle V drives vehicle V frequently for a short driving time. In view of this, in-vehicle device 110 may change the sampling period based on the driving history of vehicle V. In detail, in-vehicle device 110 may calculate, for example, the average driving time of vehicle V based on the driving history of vehicle V, and change the sampling period to a period shorter than the average driving time.

In the above embodiment and variations, outputter 25 stores the output data in second storage 32 and transmits the output data to server 200. Here, the storage and the transmission may be performed simultaneously or at different times. For example, when the communication status between server 200 and communicator 26 is poor, outputter 25 stores the output data in second storage 32 without transmitting the output data to server 200. Once the communication status between server 200 and communicator 26 is improved, outputter 25 transmits the output data to server 200.

Although outputter 25 outputs the output data upon determining that in-vehicle device 110 is in the termination process in Step S6 (Step S6: Yes) in the above embodiment and variations, outputter 25 may output the output data when in-vehicle device 110 is restarted after the termination process. The restart is performed, for example, when the ignition switch of vehicle V is turned on.

In the above embodiment and variations, outputter 25 outputs the output data upon determining that in-vehicle device 110 is in the termination process in Step S6 (Step S6: Yes). In the case where in-vehicle device 110 performs the termination process when the ignition switch of vehicle V is turned off, if the ignition switch of vehicle V is frequently turned on and off, the frequency of transmission of the output data to server 200 increases. Therefore, outputter 25 may limit the number of times the output data is transmitted in a predetermined period to less than or equal to a threshold. The predetermined period may be, for example, one day, and the threshold may be, for example, one time. This can reduce the frequency of transmission of output data.

The process operation of in-vehicle device 110 in the above embodiment and the process operation of in-vehicle device 110 in Variation 1 may be switched. In other words, whether to use a sampling period may be switched. In this case, the type of numerical value indicated by the degenerate data may be switched depending on whether to use a sampling period. For example, when a sampling period is not used, the degenerate data may indicate at least one of the largest value or the smallest value of the numerical values indicated by the two or more items of obtainment data. When a sampling period is used, the degenerate data may indicate at least one of the mode value, median value, average value, or histogram of the numerical values indicated by the two or more items of obtainment data. In the above embodiment, outputter 25 outputs, for example, the degenerate data for each extraction period as output data upon determining that in-vehicle device 110 is in the termination process in Step S6 (Step S6: Yes). Here, first storage 31 may store only the degenerate data for the most recent five extraction periods, as an example. In this case, outputter 25 may select only the degenerate data of the oldest extraction period from among the five items of degenerate data, and output the degenerate data as output data. This can prevent degenerate data obtained close to the timing of the termination process of in-vehicle device 110 from being output as output data, so that only highly reliable degenerate data can be output as output data.

In the above embodiment and variations, in-vehicle device 110 may obtain data related to each processor, such as GPU 12, DSP 14, and AI accelerator 15, as obtainment data. Condition determiner 23 may then determine whether the data satisfies the extraction condition corresponding to the data, and output the obtainment data that satisfies the extraction condition to degenerate data calculator 24 as extracted obtainment data.

Each of the structural elements in the above embodiment and variations may be configured in the form of a dedicated circuit or hardware, or may be implemented by executing a software program suitable for the structural element. Each of the structural elements may be implemented by means of a program executing unit, such as a CPU and a processor, reading and executing the software program recorded on a recording medium such as a hard disk or semiconductor memory. A program, which is software that implements the device or system according to the above embodiment, causes a computer to execute each step included in the flowcharts of FIGS. 5, 7, and 8.

The following are also included in the scope of the present disclosure.
(1) The above device or system is specifically a computer system including a microprocessor, a read only memory (ROM), a random access memory (RAM), a hard disk unit, a display unit, a keyboard, a mouse, and the like. A computer program is recorded in the RAM or the hard disk unit. The above device or system achieves its functions by the microprocessor operating according to the computer program. The computer program is configured by combining multiple command codes indicating instructions to the computer, to achieve predetermined functions.
(2) Part or all of the structural elements constituting the above device or system may be configured as a single system large scale integration (LSI). A system LSI is a super-multifunctional LSI manufactured integrating multiple components on a single chip, and specifically is a computer system including a microprocessor, a ROM, a RAM, and the like. A computer program is recorded in the RAM. The system LSI achieves its functions by the microprocessor operating according to the computer program.
(3) Part or all of the structural elements constituting the above device or system may be configured as an IC card detachably mountable to the device or system or a standalone module. The IC card or the module is a computer system including a microprocessor, a ROM, a RAM, and the like. The IC card or the module may include the above-described super-multifunctional LSI. The IC card or the module achieves its functions by the microprocessor operating according to the computer program. The IC card or the module may be tamper-resistant.
(4) The present disclosure may be the above-described methods, or may be a computer program which realizes these methods by a computer, or may be digital signals made up of the computer program.

The present disclosure may be the computer program or the digital signals recorded on a computer-readable recording medium, such as flexible disk, hard disk, compact disc (CD)-ROM, DVD, DVD-ROM, DVD-RAM, Blu-ray (registered trademark) disc (BD), or semiconductor memory. The present disclosure may also be the digital signals recorded on these recording mediums.

The present disclosure may be an arrangement where the computer program or the digital signals are transmitted over an electric communication line, a wireless or wired communication line, a network such as the Internet, data broadcasting, or the like.

The present disclosure may also be carried out by another independent computer system, by the program or the digital signals being recorded on the recording medium and being transported, or by the program or the digital signals being transferred over the network or the like.

While an embodiment and its variations have been described herein above, it is to be appreciated that various changes in form and detail may be made without departing from the spirit and scope of the present disclosure as presently or hereafter claimed.

Further Information about Technical Background to this Application

The disclosure of the following patent application including specification, drawings, and claims is incorporated herein by reference in their entirety: Japanese Patent Application No. 2024-103166 filed on Jun. 26, 2024.

### INDUSTRIAL APPLICABILITY

The In-vehicle device according to the present disclosure can reduce the amount of data that is output while enabling easy understanding of the operation status of the CPU from the data, and can be used for devices or systems provided in vehicles.

1. An in-vehicle device provided in a vehicle, the in-vehicle device comprising:
a central processing unit (CPU);
an obtainment circuit that repeatedly obtains obtainment data indicating at least an operation status of the CPU;
a condition determination circuit that determines, for each of a plurality of items of obtainment data resulting from repeatedly obtaining the obtainment data, whether the item of obtainment data satisfies an extraction condition set in advance; and
an output circuit that outputs output data based only on one or more items of obtainment data determined to satisfy the extraction condition from among the plurality of items of obtainment data.

2. The in-vehicle device according to claim 1, further comprising:
a communication circuit that communicates with a server outside the vehicle,
wherein the output circuit outputs the output data by causing the communication circuit to transmit the output data to the server.

3. The in-vehicle device according to claim 1, further comprising:
a first memory that stores the output data; and
a second memory,
wherein the output circuit outputs the output data by reading the output data from the first memory and storing the output data in the second memory.

4. The in-vehicle device according to claim 1, further comprising:
a degenerate data calculation circuit that, when the condition determination circuit determines that two or more items of obtainment data satisfy the extraction condition from among the plurality of items of obtainment data, calculates degenerate data from the two or more items of obtainment data determined to satisfy the extraction condition, the degenerate data being smaller in data amount than a total of the two or more items of obtainment data,
wherein the output circuit outputs the degenerate data as the output data.

5. The in-vehicle device according to claim 4,
wherein for each extraction period during which obtainment data satisfying the extraction condition is repeatedly and continuously obtained by the obtainment circuit, the degenerate data calculation circuit calculates the degenerate data based on the two or more items of obtainment data obtained by the obtainment circuit during the extraction period.

6. The in-vehicle device according to claim 4,
wherein each of the two or more items of obtainment data determined to satisfy the extraction condition indicates a numerical value as the operation status of the CPU, and
the degenerate data indicates a largest value, a smallest value, a mode value, a median value, an average value, or a histogram of numerical values indicated by the two or more items of obtainment data.

7. The in-vehicle device according to claim 1,
wherein the output circuit outputs the output data when an ignition switch of the vehicle is turned off or when processing of the in-vehicle device ends.

8. The in-vehicle device according to claim 1,
wherein the output circuit outputs, for each sampling period set in advance, output data corresponding to a plurality of items of obtainment data obtained in the sampling period.

9. The in-vehicle device according to claim 1,
wherein the obtainment data indicates at least one of an operation rate of the CPU or a temperature related to the CPU as the operation status of the CPU, and
the temperature related to the CPU includes at least one of a temperature of the CPU, an internal temperature of the in-vehicle device, or an external temperature of the vehicle.

10. The in-vehicle device according to claim 1,
wherein the obtainment data indicates a numerical value as the operation status of the CPU, and
the extraction condition is any one of (1) the numerical value being greater than or equal to a first threshold, (2) the numerical value being less than or equal to a second threshold, or (3) the numerical value being within a predetermined range.

11. The in-vehicle device according to claim 9,
wherein the obtainment data indicates the operation rate of the CPU and the temperature related to the CPU,
the extraction condition includes a first condition for the operation rate indicated by the obtainment data and a second condition for the temperature indicated by the obtainment data, and
the condition determination circuit determines that the item of obtainment data satisfies the extraction condition when the operation rate satisfies the first condition and the temperature satisfies the second condition.

12. The in-vehicle device according to claim 9,
wherein the obtainment data indicates the operation rate of the CPU and the temperature related to the CPU, the condition determination circuit determines, for each of the plurality of items of obtainment data resulting from repeatedly obtaining the obtainment data, whether a first numerical value that is one of the operation rate or the temperature indicated by the item of obtainment data satisfies the extraction condition, and
the output circuit outputs, for each of the one or more items of obtainment data determined to satisfy the extraction condition, the output data based on a second numerical value that is an other one of the operation rate or the temperature indicated by the item of obtainment data.

13. The in-vehicle device according to claim 1,
wherein the output circuit outputs the output data based on a duration time during which the one or more items of obtainment data determined to satisfy the extraction condition from among the plurality of items of obtainment data are continuously obtained by the obtainment circuit.

14. An output method executed by an in-vehicle device that is provided in a vehicle and includes a central processing unit (CPU), the output method comprising:
repeatedly obtaining obtainment data indicating at least an operation status of the CPU;
determining, for each of a plurality of items of obtainment data resulting from repeatedly obtaining the obtainment data, whether the item of obtainment data satisfies an extraction condition set in advance; and
outputting output data based only on one or more items of obtainment data determined to satisfy the extraction condition from among the plurality of items of obtainment data.
